(19) United States
(12) Patent Application Publication
(10) Pub. No.: US 2004/0181380 A1
(43) Pub. Date: Sep. 16, 2004

(54) Simulation method and program product

(76) Inventors: Mitsunobu Yoshida, Kawasaki-shi (JP); Koichi Kondo, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/743,086

(22) Filed: Dec. 23, 2003

(30) Foreign Application Priority Data
Dec. 26, 2002 (JP) 2002-376210

(51) Int. Cl. G06G 7/48

(52) U.S. Cl. 703/7

(57) ABSTRACT

A method of simulating a behavior of a mechanism on the basis of description data using a hybrid model. The description data is parsed to extract a description of continuous system equations, a description of switching of the continuous system equations upon state transition, and a description of an additional process other than any process relating to the continuous system equations. A simulation of the behavior of the mechanism is executed, wherein an activated continuous system equations is solved by numerical integration. The additional process is executed in response to occurrence of an event which may integrally be managed with other events relating to the continuous system equations.

### CROSS-REFERENCE TO RELATED APPLICATIONS

This application is based upon and claims the benefit of priority from the prior Japanese Patent Application No. 2002-376210, filed Dec. 26, 2002, the entire contents of which are incorporated herein by reference.

### BACKGROUND OF THE INVENTION

1. Field of the Invention

The present invention relates to a method, program product for simulating the behavior of a mechanism using a hybrid model.

2. Description of the Related Art

Nowadays, upon simulating the behaviors of a machine, plant, and the like using a computer, a scheme called hybrid modeling is often used. A simulation using a hybrid model is called a “hybrid simulation”. A system that carries out such simulation is called a “hybrid system”.

A hybrid model, which is generated for the purpose of simulation, combines, in principle, a continuous system model expressed by simultaneous equations of ordinary differential equations or algebraic equations, and a state transition model used to express state transition upon occurrence (establishment) of an event. The hybrid model can expresses a system whose state is expressed by a continuous system model and is switched instantaneously in response to, e.g., an external event.

As a language that describes a hybrid model, HCC (Hybrid Concurrent Constraint Programming) created at the Palo Alto Research Center of Xerox Corporation (trade mark) is known (see “www2.parc.com/spl/projects/mbc/publications.html#cclan guages”). HCC is under development, and is currently being studied at the NASA Ames Research Center. HCC is a kind of technology called constraint programming, and can handle ordinary differential equations or algebraic equations that express a continuous system model as constraints, and can describe these equations in random order. The hybrid model is completed by adding a description that controls state transition to such constraint description. Such HCC can directly list up (program) equations as constraints, and can describe a complex model.

As described above, the hybrid model technology can express system characteristics as a model using ordinary differential equations or the like, and can simulate system behavior from an initial state along with the elapse of time.

As an application example of the hybrid model technology that can adequately model objects and events which can be expressed by differential equations or the like, mechanism simulation of a mechatronics device, the mechanism of which is controlled by software, is known. According to such mechanism simulation, even when no actual mechanism is available, control software that controls the mechanism can undergo prototyping, testing, debugging, or the like.

However, a known programming language that can handle a hybrid model is not always developed for the purpose of application to the mechanism simulation of a mechatronics device. It is very difficult for users to easily and accurately create a hybrid model for simulating a behavior of a complex mechanism system.

### BRIEF SUMMARY OF THE INVENTION

The present invention is directed to a simulation method and a program product in which a mechanism system can easily and accurately be modeled using a hybrid model.

According to embodiments of the present invention, there is provided a method of simulating a behavior of a mechanism on the basis of description data using a hybrid model. The description data is parsed to extract a description of continuous system equations, a description of switching of the continuous system equations upon state transition, and a description of an additional process other than any process relating to the continuous system equations. A simulation of the behavior of the mechanism is executed, wherein an activated continuous system equations is solved by numerical integration. The additional process is executed in response to occurrence of an event which may integrally be managed with other events relating to the continuous system equations.

### BRIEF DESCRIPTION OF THE SEVERAL VIEWS OF THE DRAWING

FIG. 1 is a schematic block diagram showing the arrangement of a mechanism simulator according to a first embodiment of the present invention;

FIG. 2 shows a given state of a cylinder device according to a practical example used to explain a hybrid model description;

FIG. 3 shows another state of the cylinder device according to the practical example used to explain the hybrid model description;

FIG. 4 shows state transition of the cylinder device according to the practical example used to explain the hybrid model description;

FIG. 5 shows the contents of the hybrid model description;

FIG. 6 is an explanatory view of an internal data structure obtained as a result of parsing one continuous system equation;

FIG. 7 is a flowchart showing the processing procedure of mechanism simulation;

FIG. 8 is an explanatory view of the time-series flow of mechanism simulation;

FIG. 9 is a schematic block diagram showing the arrangement of a mechanism simulator according to a second embodiment of the present invention;

FIG. 10 shows an example of the contents of a hybrid model description in the second embodiment of the present invention; and

FIG. 11 is a flowchart showing the operation of the mechanism simulator according to the second embodiment of the present invention.

### DETAILED DESCRIPTION OF THE INVENTION

Embodiments of the present invention will be described hereinafter with reference to the accompanying drawings.

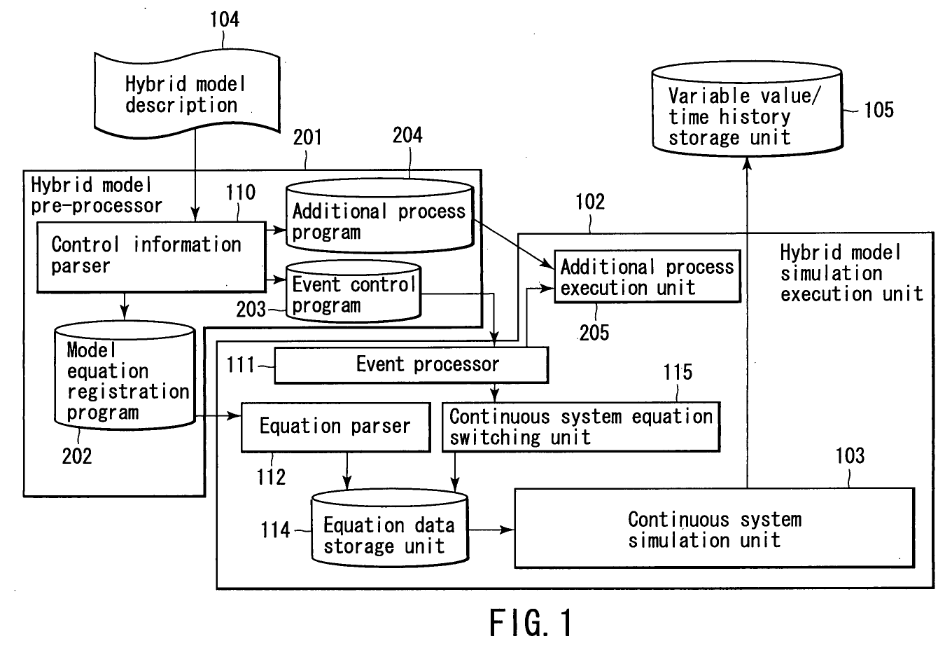

FIG. 1 is a schematic block diagram showing the arrangement of a mechanism simulator according to an embodiment of the present invention.

A simulator of this embodiment comprises a hybrid model pre-processor 201 and hybrid model simulation execution unit 102. A hybrid model description 104 is a source program described in a hybrid model description language or the like, and is an input to the hybrid model pre-processor 201 according to this embodiment. The output from the hybrid model simulation execution unit 102 according to this embodiment is the calculation result and time history of variable values as a simulation result, and is output to a variable value/time history storage unit 105 and stored therein.

As shown in FIG. 1, the hybrid model pre-processor 201 comprises a control information parser 110. The hybrid model simulation execution unit 102 comprises an event processor 111, equation parser 112, equation data storage unit 114, continuous system equation switching unit 115, additional process execution unit 205, and continuous system simulation unit 103. Note that this embodiment can be implemented using a general computer, which comprises as its basic hardware components a central processing unit (CPU), memory, external recording device, communication interface (I/F), display device, and input device (keyboard, mouse, and the like), none of which are shown. Also, the computer comprises an operating system (OS) for controlling these hardware components. The mechanism simulator according to the embodiment of the present invention can be implemented as application software, which runs on such operating system.

Prior to a description of the arrangement and processing procedure of the mechanism simulator according to this embodiment, how to describe the hybrid model 104 will be described below taking a practical example.

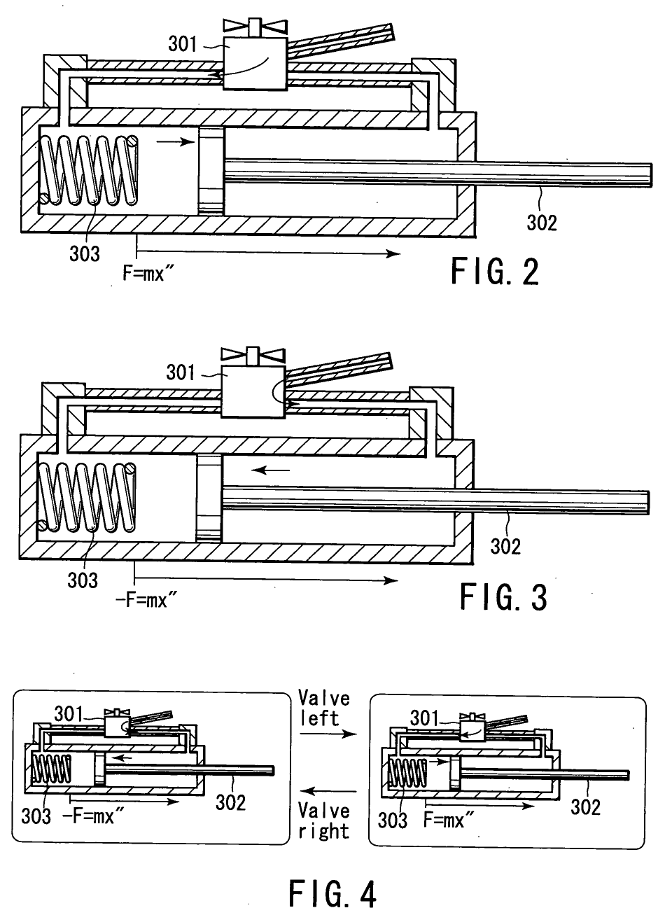

FIGS. 2 and 3 show a mechanism, a hybrid model of which is to be described according to the practical example. This mechanism is a cylinder device having a simple structure, which comprises a valve 301, spring 303, and piston 302.

The valve 301 opens/closes in response to an external instruction (event). An event that changes the air flow in the cylinder device to the right side, as shown in FIG. 2, will be referred to as “Left” hereinafter, and an event that changes the air flow to the left side, as shown in FIG. 3, will be referred to as “Right” hereinafter. FIG. 2 shows a state wherein the “Light” event is given to the valve 301, and a rightward force on the plane of paper of FIG. 2 acts on the piston 302. A dynamic equation that expresses this state is [−F=mx″], as indicated by an equation below the cylinder device. In contrast, FIG. 3 shows a state wherein the “Right” event is given to the valve 301. In this state, the air flow direction has changed, and the dynamic equation changes to [F=mx″], as shown in FIG. 3.

FIG. 4 expresses the behaviors of such mechanism as a state transition chart including state transitions and the dynamic equations corresponding to these states. A hybrid model expresses the state transition and respective states shown in FIG. 4 described using differential equations or algebraic equations. As can be seen from FIG. 4, there are two states, and state transition occurs between these two states.

In embodiments of the present invention, the hybrid model description 104 is generated as follows. That is, the contents of a practical hybrid model are described in HCC (Hybrid Concurrent Constraint Programming) language on the basis of the state transition chart of FIG. 4. Also, a process other than those expressed by continuous system equations, e.g., a process associated with collaboration with an external system (to be referred to as an “additional process” hereinafter) is described in a predetermined programming language. An additional process comprises a specific, determined process other than any process relating to continuous system equations. It is required that an additional process does not depend on time such as time integration.

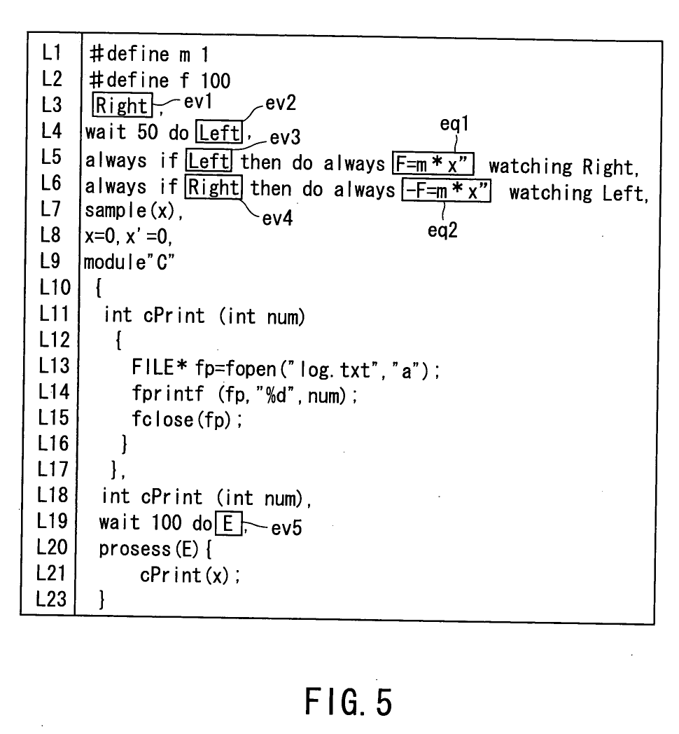

FIG. 5 shows an example of a program which corresponds to the hybrid model description according to the present invention. Referring to FIG. 5, let L1 to L23 be the logical line numbers of a (source) program. L3, L4, and L8 describe the initial state and drive conditions such as a valve manipulation timing of the aforementioned mechanical device. L5 and L6 correspond to state transition expressions shown in FIG. 4. Also, L9 to L23 correspond to a description associated with an additional process, and describe a process “write a current state in a file”. Note that there is a description block (L9 to L17) contained in a statement named “module”, wherein “C” is specified. Hence, in this block, a program is described in C language.

In HCC, dynamic equations can directly be described in the program, as can be seen from L5 and L6 in FIG. 5. L5 and L6 differ in state. In each state, a condition required to transit thereto is referred to as “precondition”, which can be described after “always if”. A condition required to transit from each state is referred to as “transition condition”, which can be described after “watching”.

Note that the program described in HCC is not always executed according to its description order (e.g., the order of logical line numbers L1→L8 in FIG. 5). In HCC, individual program statements which are to be activated are searched along the time axis along which a simulation is executed, and are executed. That is, the order of logical line numbers L1→L8 is not related to their execution order. For example, at the beginning of the simulation, only L3 and L8 are active. Since event “Right” (ev1) is generated in L3, “Right” as the precondition of L6 is activated, and dynamic equation eq2 described if L6 is activated. That is, the simulation is executed from the left state in FIG. 4.

Furthermore, when the time has reached “50”, L4 is activated, and event “Left” (ev2) is generated to effect the transition condition (after “watching”, i.e. Left) of L6, thus deactivating dynamic equation eq2 in L6. Instead, the precondition of L5 is activated, and dynamic equation eq1 is activated.

Note that the aforementioned program example describes a case wherein state transition (L5, L6) occurs in response to external events. Of course, the state may transit to another depending on the internal situation. For example, when the valve 301 is not switched in FIG. 2, the moving piston 302 contacts the spring 303, and receives a counter force it. That is, state transition may occur in association with the position of the piston 302 even when no external event is input. In such case, the necessity of state transition can be determined by evaluating an evaluation formula (inequality) indicating, e.g., if x is positive.

In general, a hybrid model combines a continuous system model expressed by simultaneous equations of ordinary differential equations or algebraic equations, and a state transition model used to express state transition upon occurrence of an event. The hybrid model can express a system, the state of which is expressed by the continuous system model and is switched instantaneously in response to, e.g., an external event or the like.

Moreover, when the time has reached “100”, L19 is activated, and event E (ev5) is generated to call a function “cPrint” together with the value of argument x (L18 to L23). Such the description indicates execution of an additional process for saving information representing the state at that time in a file, and the specific content of this process is described in, for example, C language in L9 to L17.

Lines L18 to L23 shown in FIG. 5 describe the contents of the hybrid model description 104 used to control an additional process (L11 to L16). Of these contents, a description “process(E) {cPrint(x)}” is an instruction syntax “execute an additional process, i.e., cprint(x) upon occurrence of event E”. It should be noted here that an event associated with execution control of the additional process can be described using the same event as events Left and Right associated with switching of continuous system equations.

According to the above feature, (1) the contents of the additional process can be described on the same program source as a description corresponding to a hybrid model having switching of continuous system equations; and (2) control for, e.g., calling the additional process can be included in a hybrid description.

Therefore, this embodiment allows a user to describe a comprehensible, simple simulation model.

The process in the hybrid model pre-processor 201 will be described below. The hybrid model description 104 is processed by the control information parser 110 in the hybrid model pre-processor 201 to generate a model equation registration program 202, event control program 203, and additional process program 204. As software modules which form the hybrid model simulation execution unit 102, a function required to register model equations, and a function of switching continuous system equations are provided as API (Application Program Interface) functions. The model equation registration program 202 and event control programs 203 are prepared by appropriately combining descriptions that call the aforementioned API functions in accordance with the input hybrid model description 104. From this viewpoint, the hybrid model pre-processor 201 can be considered a type of compiler, which receives the hybrid model description 104 and outputs, e.g., a C program (source) that contains the descriptions which call API functions in C for example. The model equation registration program 202 and model equation control programs 203 are further compiled by a compiler for C or the like to generate libraries that allow dynamic links upon execution. The hybrid model simulation execution unit 102 executes a simulation program which faithfully reproduces a hybrid model, when such program is completed by linking the generated dynamic link libraries (dll) upon execution of a simulation. Note here that embodiments according to the present invention do not necessarily require dynamic linking upon execution of the generated libraries. The libraries may be static, allowing static linking upon execution.

Various specifications of practical software modules which form an application interface of the hybrid model simulation execution unit 102 are available. However, for the sake of simplicity, assume that at least the following three API functions are defined. Note that the programming language is C for example.

[Expression 1]

int XXX_AddEqnData(char *eqn, int *err)

int XXX_ActivateEqn(int eqnid)

int XXX_DeActivateEqn(int eqnid)

The first API function XXX_AddEqnData designates, as an argument, a pointer of a character string which represents one continuous system equation. XXX_AddEqnData executes a process for parsing this continuous system equation to convert it into a data structure (internal data expression) that allows execution of a simulation, and registering such internal data expression in the equation data storage unit 114. Note that a unique ID number is assigned to this continuous system equation.

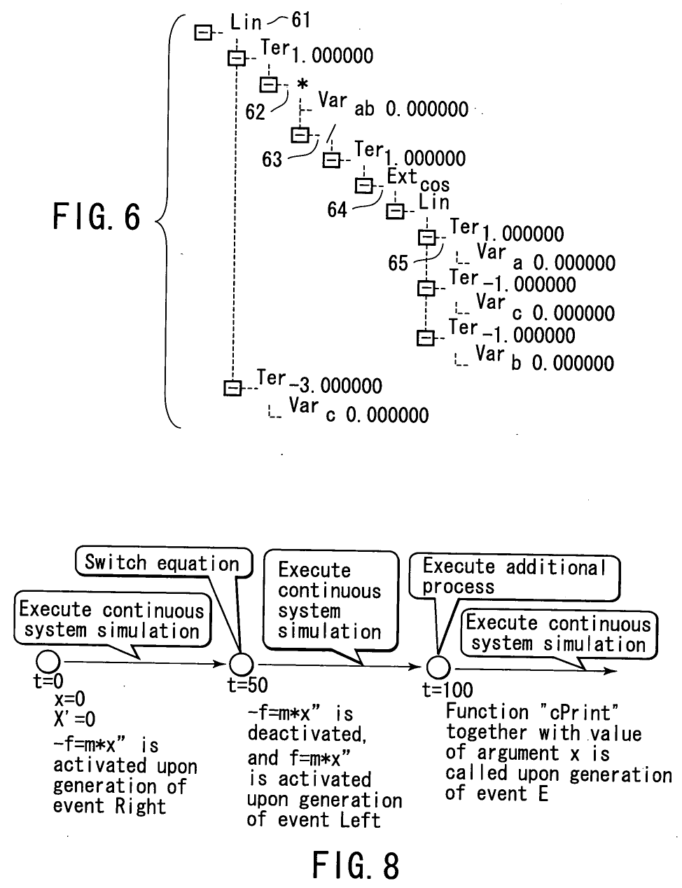

For example, assume that formula “ab/cos(a−(c+b))−3c” is given. Then, the API function generates a tree structure shown in FIG. 6 as the internal data expression. In this tree structure, for example, reference numeral 61 denotes a parent node of a linear polynomial; 62, a multiplication node; 63, a division node; 64, an external function (other than four-function operations) node; and 65, a node of each term which forms the linear polynomial. In this example, all leaves of the tree structure correspond to variables (a, b, c), and coefficients of real numbers are added to these variables to form linear equations. Each linear equation becomes an argument of an external function such as cos or the like, or undergoes multiplication or division. Each variable independently has a flag indicating if its value has been settled, and the current value of the variable is held on the basis of such tree structure data. If the values of all the leaves (i.e., those of the variables) of the tree structure have been settled, the value of the formula can be calculated. In the equation data storage unit 114, the tree structure is formed by joining internal data structures in advance so as to calculate the value of the formula and the like at high speed.

If any error has occurred in the above process, an error code is set in err. If the process has normally terminated, the ID number of the registered equation is output as a return value.

The second API function XXX_ActivateEqn activates an equation corresponding to the equation ID number designated as an argument. If an equation that has already been activated is designated, no process is made. The return value is an error code.

The third API function XXX_DeActivateEqn deactivates an equation corresponding to the equation ID number designated as an argument, contrary to XXX_ActivateEqn. If an equation that has already been deactivated is designated, no process is made.

The control information parser 110 generates a function (InitEqnData) that calls XXX_AddEqnData in turn for required equations. This corresponds to the model equation registration program 202 (first program).

Also, the control information parser 110 generates a function (ChangeEqn) that checks a condition and changes (replaces) an equation every time the time advances Δt upon executing a simulation. This corresponds to the event control program 203 (second program).

The ChangeEqn function detects occurrence of events Left, Right, and E by a GetEvent function. The ChangeEqn function is called from the event processor 111 at each time step upon execution of a simulation.

As shown in FIG. 1, in the hybrid model simulation execution unit 102, the event processor 111 and continuous system simulation unit 103 are configured so that they are separated. For that purpose, the event control program 203 must not contain any module which depends on time such as time integration or the like. Also, the event processor 111 performs only switching of active/inactive flags of continuous system equations.

With this simulator architecture, events associated with interfaces with external devices and those associated with a hybrid description can be managed in a common, single process (such as if(getEvent(event) {process}).

The hybrid model pre-processor 201 can easily generate a hybrid simulation execution program since it temporarily outputs a hybrid simulation model using the same language as the additional process.

In this way, collaboration between a hybrid simulation and external devices can be facilitated.

Furthermore, the control information parser 110 extracts a content description of the additional process from the hybrid model description 104. Such description corresponds to the additional process program 204 (third program). The additional process program 204 is originally described in C or the like in the hybrid model description 104. For example, in the hybrid model description 104 shown in FIG. 5, a module statement is looked up to extract a field described in C. The additional process program 204 is compiled by a C compiler to generate a library that allows dynamic linking. The additional process execution unit 205 serves as an interface which calls this library that allows dynamic link. Note here that embodiments according to the present invention do not necessarily require dynamic linking upon execution of the generated library. The library may be static, allowing static linking upon execution. Needless to say, languages used for describing the contents of additional processes are not limited to C language.

With the aforementioned processes in the hybrid model pre-processor 201, for example, the following C source program is automatically generated in association with the hybrid model description shown in FIG. 5.

[Expression 2]

```
static char eqn1[] =“f=mx′′”;
static char eqn2[] =“−f=mx′′”;
static mt eqn1id;
static mt eqn2id;
int InitEqnData( )
{
    int err;
    eqn1id = XXX_AddEqnData(eqn1,&err);
    if(err!=0)return err;
    eqn2id = XXX_AddEqnData(eqn2,&err);
    if(err!=0)return err;
    return 0;
}
int ChangeEqn( )
{
int err;
BOOL GetEvent(char *eventname);
If(GetEvent(“Left”)){
    Err = XXX_ActivateEqn(eqn1id);
    if(err!=0)return err;
    XXX_DeActivateEqn(eqn2id);
    if(err!=0)return err;
}
if(GetEvent(“Right”)){
    XXX_ActivateEqn(eqn2id);
    if(err!=0)return err;
    XXX_DeActivateEqn(eqn1id);
    if(err!=0)return err;
}
if(GetEvent(“E”)){
    cPrint(x);
}
return 0;
}
int cPrint(int num)
{
    FILE *fp=fopen(“log.txt”,“a”);
    fprintf(fp, “%d”,num);
    fclose (fp);
}
```

Note that GetEvent is a function of checking if an event whose name (eventname) is designated as an argument has occurred.

The aforementioned problem is compiled by a C compiler, is shaped in the form of the dynamic link library, and is linked upon execution.

In this embodiment, C has been exemplified as a programming language. However, the present invention is not limited to such specific language, and other programming languages such as C++, SpecC, and the like may be used.

Execution of a simulation will be explained below. Upon execution of a simulation, the hybrid model simulation execution unit 102 is launched, and executes a simulation by calculating continuous system equation values. At this time, the continuous system equation switching unit 115 is internally called by the event processor 111, and switches continuous system equations using active/inactive flags. The event processor 111 corresponds to the event control program 203 generated in the pre-process (second program; ChangeEqn). In the state shown in FIG. 2, dynamic equation eq1 in FIG. 5 is inactive, and dynamic equation eq2 is active. In the state shown in FIG. 3 after the “Left” event is generated, the unit 115 manipulates flags to activate dynamic equation eq1 in FIG. 5, and to deactivate dynamic equation eq2. These active/inactive flags are managed as attribute data of equations stored in the equation data storage unit 114.

The continuous system simulation unit 103 looks up the equation data storage unit 114, and executes numerical integration in increments of time steps to have the internal data expression of each continuous system equations stored in the form of the tree structure in the storage unit 114 as a calculation target. A simulation is an initial value problem for nonlinear simultaneous equations as simultaneous equations of ordinary differential equations and algebraic equations. Hence, an initial state shown in FIG. 2 is given. More specifically, a solution value is calculated using, e.g., the popular Runge-Kutta algorithm.

Required data are output from the mechanism simulator, and the control returns to the process of the continuous system equation switching unit 115 to repeat the above processes, thus executing a simulation for a required period of time. The simulation result is saved in the variable value/time history storage unit 105, and is used in analysis and the like after the simulation.

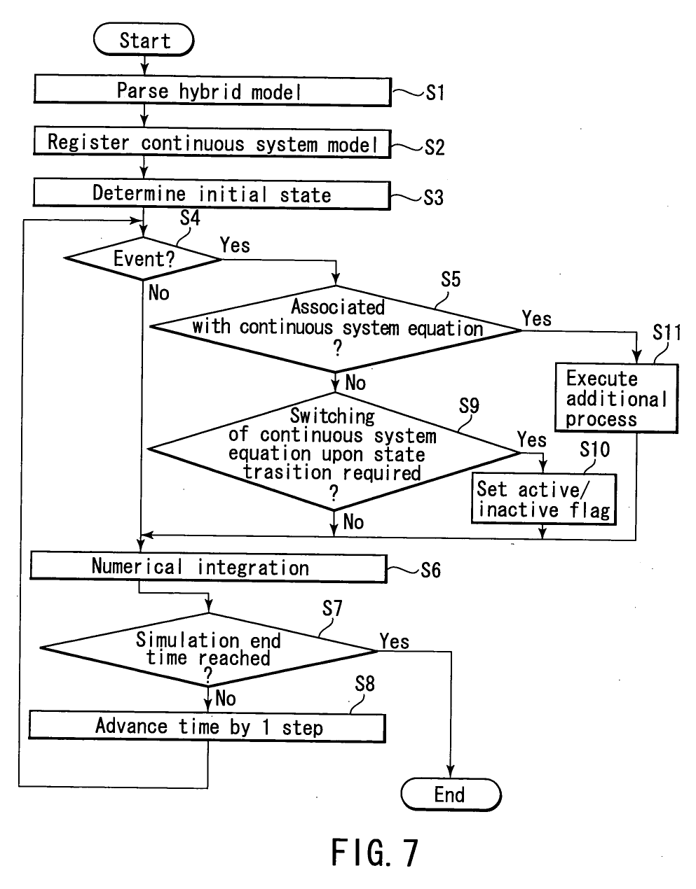

FIG. 7 is a flowchart showing a series of processes in a simulation according to the first embodiment of the present invention. The processes may broadly be grouped under a process for pre-processing a hybrid model and a process for executing a simulation using the pre-processed model.

Referring now to FIG. 7, in step S1, the hybrid model description 104 is input to a control information parser 110. The control information parser 110 parses the hybrid model description 104 to generate a model equation registration program 202, event control program 203, and additional process program 204, as shown in FIG. 1. The pre-process for a simulation has been done in step S1, and a simulation execution process then starts.

The hybrid model simulation execution unit 102 makes a call to the equation parser 112. The equation parser 112 corresponds to the model equation registration program 202 (first program; InitEqnData), which in turn makes an call to an API function XXX_AddEqnData. This API function converts description data of continuous system equations into data structures that allow a simulation. The converted data is then stored in an equation data storage unit 114 (step S2).

After a state based on the description of hybrid model description 104 has been initialized in step S3, it is checked in step S4 if an event is occurred. For this purpose, the hybrid model simulation execution unit 102 makes a call to the event processor 111. The event processor 111 corresponds to the event control program 203 (second program; ChangeEqn), wherein the GetEvent function is called internally. If an event is occurred, control advance to step S5. If an occurrence of an event is not detected, control advance to step S6 and the continuous system simulation unit 103 executes numerical integration.

In step S5, it is checked if the occurred event is being associated with an additional process. If the event is not being associated with an additional process, it is checked in step S9 if switching of continuous system equations in accordance with state transition is required. If switching of equations is required, an active continuous system equation is switched by manipulating active/inactive flags in step S10. For this purpose, API functions XXX_ActivateEqn or XXX_DeActivateEqn is called. After execution of step S9 or step S10, control advance to step S6 and the continuous system simulation unit 103 executes numerical integration.

If the event is being associated with an additional process, an appropriate additional process is executed in step 11. As an example of a practical additional process, a process for displaying the progress of simulation processes on a screen, a process for outputting data associated with the simulation to a file, and the like may be executed. After execution of the additional process, control advance to step S6 and the continuous system simulation unit 103 executes numerical integration.

In step S7, an end condition is checked. In this case, it is checked if the time has reached a prescribed simulation end time. If the simulation end time has been reached, simulation execution ends. Before the simulation end time is reached, the time is advanced by 1 step in step S8, and control return to step S4 to repeat the same processing procedure.

FIG. 8 shows the time-series flow upon execution of the aforementioned processes in accordance with the hybrid model description shown in FIG. 5. In FIG. 8, t=0 indicates an initial state. Event “Left” is generated at t=0 to switch a continuous system equation. Event “E” is generated at t=100 to execute an additional process. During an interval between these events, a simulation of the continuous system is executed.

In order to allow the hybrid model simulation execution unit 102 to efficiently execute a simulation in collaboration with an external system (e.g., “mechanism control software simulator”) as a whole, the execution order of steps comprising the simulation must be appropriately and efficiently controlled.

In the conventional system, in order to program to appropriately and efficiently control the execution order, operations that require very high skills and involve difficulty must be made due to the characteristics (a line to be executed first cannot be determined) of the hybrid model description language (e.g., HCC). In addition, special external functions and the like associated with an interface with external processes (e.g., externally obtained information must be substituted in each variable upon processing a hybrid model in place of simply handling variable values) must be prepared, and the model creator must describe them.

Specifically, regarding the programming of the external functions, it is necessary for the model creators to follow a work flow which includes:

(1) Programming an external function in C language etc., utilizing APIs prepared for programming external functions. An HCC programming environment is provided with those APIs for programming external functions;

(2) Compiling the source program of the external function by a C compiler and creating a library (normally, “dynamic link library”) containing an object module of the external function; and

(3) Placing the library in an appropriate directory so that an HCC interpreter can determine a path of the directory and invoke the library.

Basically, the model creators bear burden on learning the APIs that are specific to HCC language. In addition, regarding a calling procedure of the external functions, it is difficult for the model creators to easily program an external function and embed it in a hybrid model source, since the creators are not sure when the external function is called and executed in context of the hybrid mode source. HCC language is not designed to manage external functions for their execution by associating them with events. In an HCC source, it is possible to describe an external function so that the external function itself is called at the moment of a state transition, or to describe another external function so that this function is called when numerical integration is performed.

In contrast, according to the embodiment of the present invention, since the hybrid model simulation execution unit 102 is configured to execute a series of processes shown in FIG. 7, the aforementioned problems can be avoided. That is, a software module corresponding to a communication with external processes such as the mechanism control software simulator 108 can be described in a programming language such as C in the hybrid model, and its function is automatically embedded in execution of the simulation. In this way, a complex simulation sequence can be flexibly modeled and programmed.

According to the first embodiment of the invention described above, a simulation method and a program product which can easily and accurately model a complex mechanism system using a hybrid model is provided. Specifically, this embodiment allows a hybrid model description to directly include a program that describes additional processes associated with collaborations with external systems. This allows a user to easily create a highly advanced, versatile simulation model and thereby to widen the application range of the simulation.

(Second Embodiment)

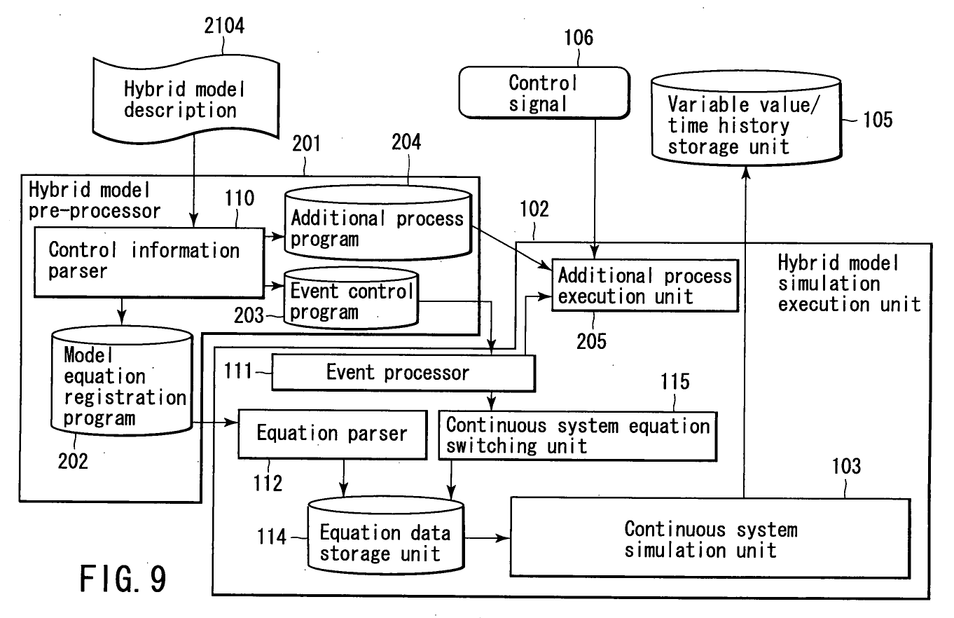

The second embodiment of the present invention relates to collaboration with a mechanism control software system or its simulator (hereinafter, referred to as “external control system”). FIG. 9 is a schematic block diagram showing the arrangement of a mechanism simulator according to the second embodiment of the present invention. The mechanism simulator of the present embodiment comprises, as well as the first embodiment, a hybrid model pre-processor 201 and hybrid model simulation execution unit 102. A control signal 106 shown in FIG. 9 is exchanged between a mechanism control software system (or its simulator, both of which are not shown) and an additional process execution unit 205, which is provided in a hybrid model simulation execution unit 102, through an input/output port.

In this embodiment, an input/output process of the control signal 106 can be defined as an additional process, and its description can be included in a hybrid model description 2104.

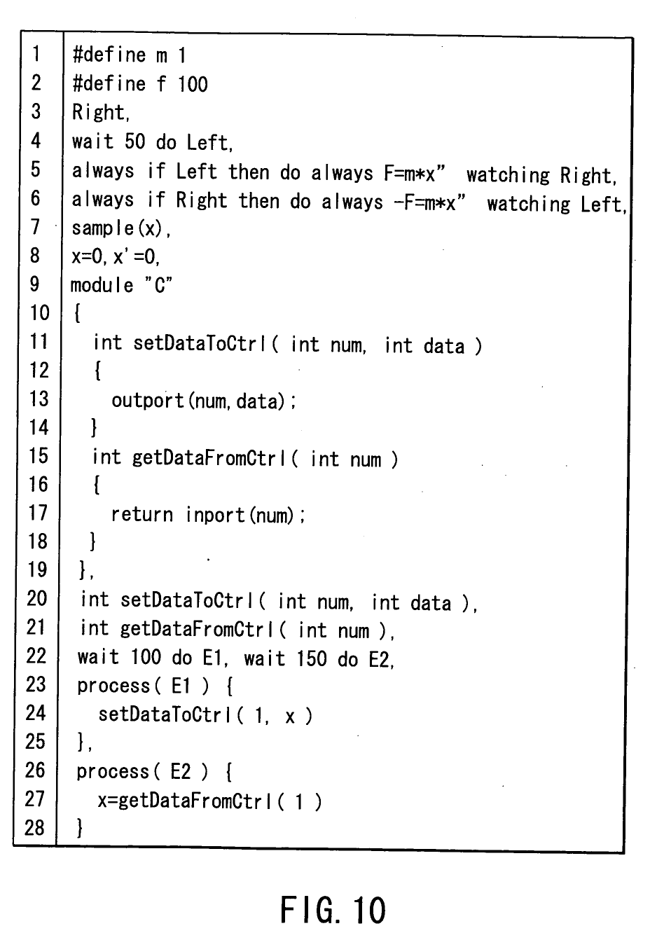

FIG. 10 shows an example of the contents of the hybrid model description 2104 in the second embodiment. An outport function is an API function used to write data in an arbitrary port ID of an external control system. An inport function is an API function of reading data from a given port ID.

The 11th to 18th lines are described in C for example. A setDataToCtrl function sets arguments num and data toward the outport function. A getDataFromCtrl function sets the (num)-th ID designated by argument num toward the inport function, and returns the acquired data as a return value.

In the 23rd and 26th lines, the setDataToCtrl and getDataFromCtrl functions are respectively associated with events E1 and E2. Upon occurrence of event E1, the setDataToCtrl function is executed; upon occurrence of event E2, the getDataFromCtrl function is executed.

In the 24th line, data x is cast into an integer type and is set in control ID number 1. In the 27th line, data acquired from the control signal 106 is forcibly set in data x.

As described above, in this hybrid simulation, a description required to achieve collaboration with an external control system to be controlled in the simulation can be easily described on the identical source. Of course, different simulation results are obtained depending on the state of the object to be controlled.

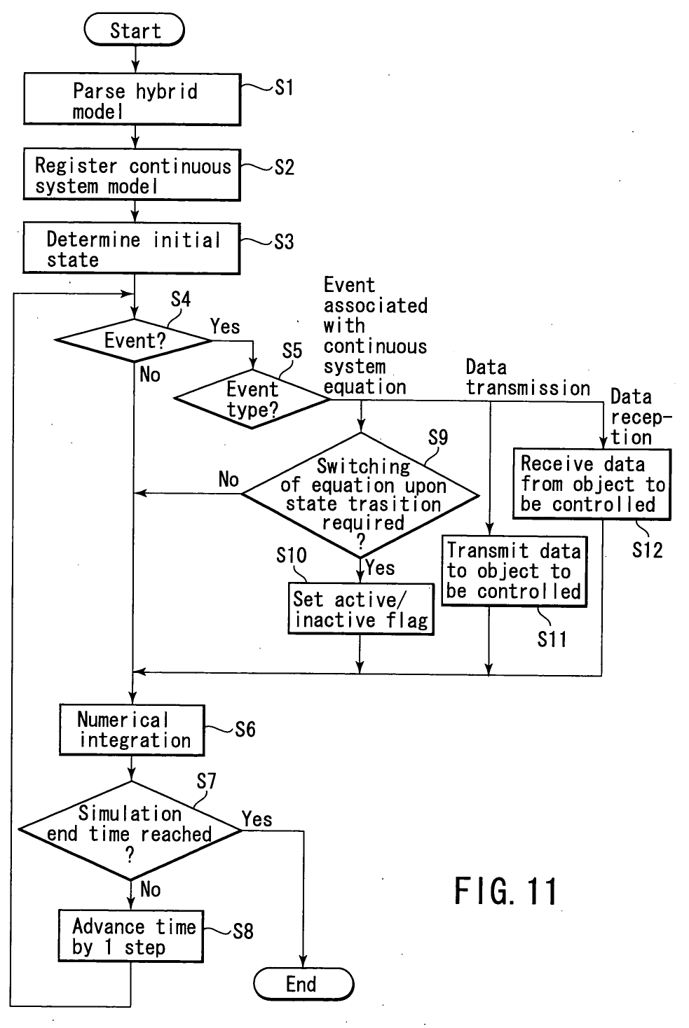

FIG. 11 is a flowchart showing the operation of the mechanism simulator according to the second embodiment of the present invention. Upon occurrence of an event, its type is specified, and the process branches depending on the event type as in the first embodiment. This embodiment is different from the first embodiment in that not only state transition in a hybrid model but also the process associated with an interface with an external control system are integrally controlled via events. As a result, the arrangement associated with a collaboration simulation with an external control system can be simple.

Referring now to FIG. 11, in step S1, the hybrid model description 2104 is input to a control information parser 110. The control information parser 110 parses the hybrid model description 2104 to generate a model equation registration program 202, event control program 203, and additional process program 204. An equation parser 112 based on the model equation registration program 202 converts description data of continuous system equations into data structures that allow a simulation, and registers them in an equation data storage unit 114 (step S2).

The pre-process for a simulation has been done, and a simulation execution process then starts.

It is checked in step S4 if an event is occurred. If an event is occurred, control advance to step S5. If an occurrence of an event is not detected, control advance to step S6.

In step S5, the type of the event is determined. If the event type indicates an event associated with continuous system equations, it is checked in step S9 if switching of continuous system equations upon state transition is required. If switching of equations is required, an active continuous system equation is switched by manipulating active/inactive flags in step S10. If switching of equations is not required, control advance to step S6.

If the type of the occurred event indicates an event associated with data transmission, data is transmitted to an external control system in step S11. The transmitted data may represent information on the status of a sensor fit on a mechanism to be simulated. On the other hand, if the type of the event indicates an event associated with data reception, data is received from the external control system in step S12.

In step S6, a continuous system simulation unit 103 executes numerical integration.

In step S7, an end condition is checked. In this case, it is checked if the time has reached a prescribed simulation end time. If the simulation end time has been reached, simulation execution ends. Before the simulation end time is reached, the time is advanced by 1 step in step S8, and control return to step S4 to repeat the same processing procedure.

The second embodiment of the present invention allows a hybrid model description to directly include a program that describes processes associated with collaborations with external systems, and thereby to widen the application range of the simulation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A simulation method of simulating a behavior of a mechanism to be simulated along a time axis on the basis of description data using a hybrid model, comprising:
parsing the description data to extract a description of continuous system equations, a description of switching of the continuous system equations upon state transition, and a description of an additional process other than any process relating to the continuous system equations;
generating a first program on the basis of the extracted description of the continuous system equations;
generating a second program on the basis of the extracted description of the switching;
generating a third program on the basis of the extracted description of the additional process;
converting, by executing the first program, data structures of the continuous system equations into other data structures that allow execution of a simulation;
switching, by executing the second program, the converted continuous system equations to activate appropriate one of the converted continuous system equations and deactivate another instead, in response to occurrence of a first event;
executing the simulation to output data that expresses the behavior of the mechanism, wherein the activated one of the continuous system equations is solved by numerical integration along the time axis according to the converted data structure; and
executing the third program to execute the additional process in response to occurrence of a second event.

2. The method according to claim 1, further comprising:
detecting an occurrence of an event; and
calling the third program if the detected event corresponds to the second event.

3. The method according to claim 1, further comprising:
exchanging a control signal with an external system through an input/output port in accordance with the third program, the external system including a mechanism control software system that control the mechanism.

4. The method according to claim 1, wherein the first event contains an evaluation result of internal variables of the mechanism.

5. A simulation program product for simulating a behavior of a mechanism to be simulated along a time axis on the basis of description data using a hybrid model, the simulation program product comprising:
means for instructing a computer to parse the description data to extract a description of continuous system equations, a description of switching of the continuous system equations upon state transition, and a description of an additional process other than any process relating to the continuous system equations;
means for instructing the computer to generate a first program on the basis of the extracted description of the continuous system equations;
means for instructing the computer to generate a second program on the basis of the extracted description of the switching;
means for instructing the computer to generate a third program on the basis of the extracted description of the additional process;
means for instructing the computer to convert, by executing the first program, data structures of the continuous system equations into other data structures that allow execution of a simulation;
means for instructing the computer to switch, by executing the second program, the converted continuous system equations to activate appropriate one of the converted continuous system equations and deactivate another instead, in response to occurrence of a first event;
means for instructing the computer to execute the simulation to output data that expresses the behavior of the mechanism, wherein the activated one of the continuous system equations is solved by numerical integration along the time axis according to the converted data structure; and
means for instructing the computer to execute the third program to execute the additional process in response to occurrence of a second event.

6. The program product according to claim 5, further comprising:
means for instructing the computer to detect an occurrence of an event; and
means for instructing the computer to call the third program if the detected event corresponds to the second event.

7. The program product according to claim 5, further comprising:
means for instructing the computer to exchange a control signal with an external system through an input/output port in accordance with the third program, the external system including a mechanism control software system that control the mechanism.

8. The program product according to claim 5, wherein the first event contains an evaluation result of internal variables of the mechanism.

9. A method for analyzing a hybrid model which is used for a simulation of a behavior of a mechanism to be simulated along a time axis, the method comprising:
parsing the hybrid model description to extract a first description associated with continuous system equations, a second description associated with state transition, and a third description associated with an additional process; and
generating a first program based on the first description, a second program based on the second description, and a third program based on the third program.

10. The method according to claim 9, wherein the third description comprises a first part which describes content of an additional process, and a second part which describes an execution control of the additional process in response to occurrence of an event.

11. The method according to claim 10, wherein the generating further comprises:
generating the third program on the basis of the first part of the third description; and
adding a program based on the second part to the second program.

12. A program product for analyzing a hybrid model which is used for a simulation of a behavior of a mechanism to be simulated along a time axis, comprising:
means for instructing a computer to parse the hybrid model description to extract a first description associated with continuous system equations, a second description associated with state transition, and a third description associated with an additional process; and
means for instructing the computer to generate a first program based on the first description, a second program based on the second description, and a third program based on the third program.

13. The program product according to claim 12, wherein the third description comprises a first part which describes content of an additional process, and a second part which describes an execution control of the additional process in response to occurrence of an event.

14. The program product according to claim 12, further comprising:
means for instructing the computer to generate the third program on the basis of the first part of the third description; and
means for instructing the computer to add a program based on the second part to the second program.

15. A simulation method for simulating a behavior of a mechanism along with a time axis, using a hybrid model including a continuous system model expressed by continuous system equations, a state transition model expressing state transition upon occurrence of described events, and an additional process model, the method comprising:
storing the continuous system model in a storage;
checking whether any one of the events described in the state transition model is occurred;
checking whether the occurred event is associated with the additional process model;
executing an additional process corresponding to the additional process model if the occurred event is associated with the additional process model; and
executing a continuous simulation on the basis of continuous system equations that are active among the continuous system model stored in the storage.

16. The method according to claim 15, wherein the executing the additional process comprises exchanging a control signal with an external system through an input/output port, the external system including a mechanism control software system that control the mechanism.

17. The method according to claim 15, further comprising switching, in response to state transition based on the state transition model, the continuous system equations that are active.

18. A program product for simulating a behavior of a mechanism along with a time axis, using a hybrid model including a continuous system model expressed by continuous system equations, a state transition model expressing state transition upon occurrence of described events, and an additional process model, the program product comprising:
means for instructing a computer to store the continuous system model;
means for instructing the computer to check whether any one of the events described in the state transition model is occurred;
means for instructing the computer to check whether the occurred event is associated with the additional process model;
means for instructing the computer to execute an additional process corresponding to the additional process model if the occurred event is associated with the additional process model; and
means for instructing the computer to execute a continuous simulation on the basis of continuous system equations that are active among the continuous system model stored in the storage.

19. The program product according to claim 18, wherein the means for instructing the computer to execute the additional process comprises means for instructing the computer to exchange a control signal with an external system through an input/output port, the external system including a mechanism control software system that control the mechanism.

20. The program product according to claim 18, further comprising means for instructing the computer to switch, in response to state transition based on the state transition model, the continuous system equations that are active.
